(19) United States
(12) Patent Application Publication
(10) Pub. No.: US 2016/0086493 A1
(43) Pub. Date: Mar. 24, 2016

(54) RUNWAY INCURSION PREVENTION SYSTEM AND METHOD

(71) Applicant: Edgar Dennis McGehee, IV, Magnolia, TX (US)

(72) Inventor: Edgar Dennis McGehee, IV, Magnolia, TX (US)

(21) Appl. No.: 14/490,593

(22) Filed: Sep. 18, 2014

(51) Int. Cl. G08G 5/00; H04N 7/18; B64F 1/36

(52) U.S. Cl. CPC G08G 5/0026; B64F 1/36; H04N 7/18

(57) ABSTRACT

A Runway Incursion Prevention System (RIPS) involves a Runway Incursion Barrier System (RIBS) and Interface Vector Imaging (IVI), with an emphasis on positively controlling ground movement to prevent runway incursions in the aviation/aerospace industry. The acronyms RIBS and IVI were intentionally removed from many patent sections herein to avoid confusion as these are not known terms with intended future trademarks use by the inventor. RIBS is detailed in a preferred embodiment to include an apparatus which acts as a physical deterrent for vehicles or can be set to completely prevent entry, a control system for manual or automatic control of barriers, and Federal Aviation Administration (FAA) regulation required changes. A primary barrier function of RIBS provides a physical visual for the safety of acceptable ground movement to assist in the reduction of human error. IVI is detailed in a preferred embodiment to include an interface to streamline RIBS, IVI, and other aviation systems; tracking between pilots and/or Air Traffic Control (ATC) in the form of a visual display; and a display screen. The interface function of IVI is to provide a visual of acceptable ground movement with take-off and landing vectors and project possible runway incursion errors based on aircraft movement commands given. RIBS and IVI are designed to work together or on their own to target the most common forms of runway incursions, which have the potential to prevent many of the estimated 75-85% of preventable incursions.

### BACKGROUND OF THE INVENTION

1. Field of the Invention

The present invention relates generally to a physical barrier that will positively control aircraft movement and an interface that will project possible errors, which will prevent runway incursions in the aviation/aerospace industry.

2. Background of the Invention

In the aviation/aerospace industry, a safety concern known as runway incursions are a primary concern by the Federal Aviation Administration (FAA), top 10 most wanted by the National Transportation Safety Board (NTSB), and The National Aeronautics and Space Administration (NASA) pilot surveys show the vast need of improvement. Runway incursions are defined by the FAA as “any occurrence at an airport involving the incorrect presence of an aircraft, vehicle or person on the protected area of a surface designated for the landing and take-off of aircraft. Surface Incidents are those incidents, which did not involve potential aircraft conflicts; those are now classified as C or D runway incursions. This adversely affects airport safety, as it creates the risk of an aircraft crashing into another aircraft, vehicle or person. Generally, these incursions are caused as a result of human error.

There are existing visual signs/marking systems currently being tested to prevent runway incursions and have made a positive impact on safety. However, these systems do not address the root problem of positively controlling aircraft and the only method to efficiently accomplish this is with a physical barrier. Barriers could be constructed with a soft or flexible material causing minor to no aircraft damage for normal traffic operations and hardened or security barrier to physically lock an airport down.

In addition, visual map displays are currently being utilized to monitor operations and have made a positive impact on making our aviation system modern. However, these existing displays fail to anticipate runway incursions to include the critical landing and take-off phases of operation. The interface herein will efficiently predict the occurrence of runway incursions to include landing and take-off phases of operation.

The following patents discuss background art related to the above discussed subject matter: U.S Patent Publication No. US20140077975 A1, published Mar. 20, 2014, to Ratan Khatwa, et al., discloses an apparatus for identifying pilot intent by sensors and actions around the runway with a display. This apparatus makes an innovative step in the right direction but fails to utilize the human element of pilot and/or ATC interaction to identify errors.

The following patents discuss background art related to the above discussed subject matter: U.S Patent Publication No. U.S. Pat. No. 8,401,774 B2, published Mar. 19, 2013, to Donald L. Ravenscroft, et al., discloses an apparatus for alerts to pilots based on location of aircraft by sensors and actions around the runway with a display. This apparatus makes an innovative step in the right direction but fails to utilize the human element of pilot and/or ATC interaction to identify errors.

The following patents discuss background art related to the above discussed subject matter: U.S Patent Publication No. U.S. Pat. No. 6,997,638 B2, published Feb. 14, 2006, to Clifford J. Hensley, et al., discloses an apparatus for an anti-terrorist road block. However, this system and similar systems in the security industry fail to utilize a physical barrier as a means to prevent aircraft traffic. This technology has only been utilized to secure a perimeter in need and not utilized as a physical barrier for aircraft traffic or anti-terrorism by locking down an airport.

The following patents discuss background art related to the above discussed subject matter: U.S Patent Publication No. U.S. Pat. No. 6,099,200 A, published Aug. 8, 2000, to John J. Pepe, et al., discloses an apparatus for an anti-terror bollard. However, this system and similar systems in the security industry fail to utilize a physical barrier as a means to prevent aircraft traffic. This technology has only been utilized to secure a perimeter in need and not utilized as a physical barrier for aircraft traffic or anti-terrorism by locking down an airport.

The following patents discuss background art related to the above discussed subject matter: U.S Patent Publication No. U.S. Pat. No. 4,576,508 A, published Mar. 18, 1986, to Harry D. Dickinson, discloses an apparatus for a bollard trafficway barrier and vehicle arrest system. However, this system and similar systems relates to traffic ways but does not include runways, taxiways or apron as utilized in the aviation industry. This technology has only been utilized to secure a perimeter in need and not utilized as a physical barrier for aircraft traffic or anti-terrorism by locking down an airport.

The above prior art does not provide a suitable solution to the above and/or other problems. There exists a need for an improved Runway Incursion Prevention System. Consequently, those skilled in the art will appreciate the present invention that addresses the above and/or other problems.

### SUMMARY OF THE INVENTION

An object of the present invention is to provide an improved Runway Incursion Prevention System.

Another object of the present invention is to provide a Runway Incursion Prevention System that will positively control aircraft movement utilizing a physical barrier to prevent runway incursions in the aviation/aerospace industry.

Yet another object of the present invention is to provide a Runway Incursion Prevention System that will project possible human errors utilizing an interface and display system to physically track aircraft movement.

These and other objects, features, and advantages of the present invention will become clear from the figures and description given hereinafter. It is understood that the objects listed above are not all inclusive and are only intended to aid in understanding the present invention, not to limit the bounds of the present invention in any way.

In accordance with the present disclosure, a preferred embodiment of a Runway Incursion Prevention System may include, but is not limited to, a Runway Incursion Barrier System (RIBS) and/or Interface Vector Imaging (IVI). However, the acronyms RIBS and IVI were intentionally removed from many patent sections herein to avoid confusion as these are not known terms with intended future trademarks use by the inventor.

More generally the present invention utilizes a Runway Incursion Barrier System, which may comprise a physical barrier, control system for manual and/or automatic operations.

In addition, more generally the present invention utilizes an Interface Vector Imaging system, which may comprise an interface and display.

The physical barrier may include flexible and/or security barriers that are designed to provide a visual for allowed pilot clearance or to physically prevent aircraft from progressing.

The physical barrier system may comprise a control system, wherein the barriers will allow clearance based on GPS, sensors, other aviation detection systems, manual control, and through commands from IVI or another interface.

The interface system may include a program utilized to allow communication between RIBS, IVI and other potential aviation systems with pilot and/or Air Traffic Control (ATC) interaction.

The interface system may comprise a type of display to visually map the airport with commands given to pilots by ATC or actions by aircraft, vehicle or personnel.

In another embodiment of the present invention, a method for a Runway Incursion Prevention System for use with positively controlling aircraft movement and an interface that will project possible errors, which will prevent runway incursions in the aviation/aerospace industry.

The method may comprise a physical barrier utilized to conduct normal traffic or a security barrier positioned to lock down an airport. Traditional security measures or utilizing the fire department to lock aircraft traffic down is not efficient due to the response time and how quickly an aircraft could take-off which causes an elevated situation. Aircraft are much easier to control on the ground with a much higher rate of success.

The method may further comprise providing an interface configured so that when ATC permits movement through an area, he/she should mark the direction of travel and if a conflicting movement is marked based on other movement, an error will pop up to alert pilots and/or ATC. Another step will call for cross-checking and prevent many root causes of runway incursions. Furthermore, at the ATC can utilize said interface to mark direction of travel from landing or take-off aircraft to prevent incursions from a very critical moment in air transportation.

The method may comprise further steps, such as communication to the Federal Aviation Administration (FAA) or other government agencies to allow this innovative Runway Incursion Prevention System into the industry.

### BRIEF DESCRIPTION OF THE DRAWINGS

The above general description and the following detailed description are merely illustrative of the generic invention, and additional modes, advantages, and particulars of this invention will be readily suggested to those skilled in the art without departing from the spirit and scope of the invention. A more complete understanding of the invention and many of the attendant advantages thereto will be readily appreciated by reference to the following detailed description when considered in conjunction with the accompanying drawings, wherein like reference numerals refer to like parts and wherein:

FIG. 1 is a block diagram of a Runway Incursion Prevention System in accord with one possible embodiment of the present invention.

FIG. 2 is a block diagram of a Runway Incursion Barrier System in accord with one possible embodiment of the present invention.

FIG. 3 is a perspective view of a physical barrier with a housing area underground in accord with one possible embodiment of the present invention.

FIG. 4 is a flowchart of the life cycle for a Runway Incursion Prevention System in accord with one possible embodiment of the present invention.

FIG. 5 is a perspective view of an Interface Vector Imaging with interface and display screen in accord with one possible embodiment of the present invention.

FIG. 6 is a block diagram of an interface in accord with one possible embodiment of the present invention.

FIG. 7 is a block diagram of a display in accord with one possible embodiment of the present invention.

### DETAILED DESCRIPTION OF THE PREFERRED EMBODIMENT

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In a preferred embodiment, runway incursion prevention system is designed prevent runway incursions when a product is being utilized. A product will have a Runway Incursion Barrier System and Interface Vector Imaging. The system is novel in that physical barriers will positively control aircraft movement and an interface will project possible errors based on interaction, which will prevent runway incursions in the aviation/aerospace industry.

In a preferred embodiment, the system is designed so that the physical barriers will be positioned to accomplish traffic or security requirements. Airport operations will have more control over traffic for the same reasons physical barriers are utilized in the railroad industry in replacement for stop signs or stop lights. This is the result in the catastrophic consequences of possible accidents in an airport over a road in the middle of nowhere to control traffic with stop signs.

In a preferred embodiment, airport operations will also have an interface and display with the ability to successfully monitor the progress for operations. This will include marking the direction of landing or take off aircraft to have the system detect errors in preventing crossing aircraft or other danger.

While the preferred embodiment of the present invention relates generally to the aviation/aerospace industry, the application of this system could be used to track operations or prevent accidents in other industries, such as, but not limited to, oil and gas, transportation, retail, and the like.

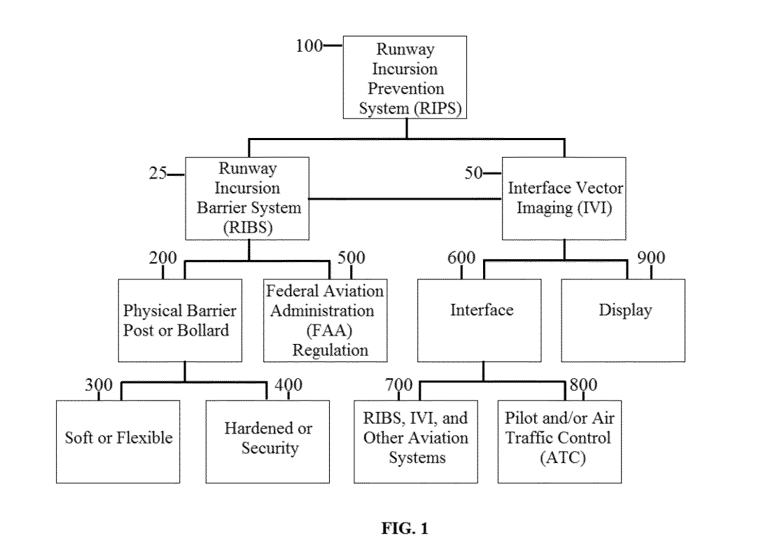

Turning now to FIG. 1, there is shown a block diagram of a Runway Incursion Prevention System 100 in accord with one possible embodiment. In this embodiment, Runway Incursion Barrier System (RIBS) 25 and Interface Vector Imaging (IVI) 50 will in conjunction or as separate systems be utilized to prevent runway incursions and the like, consistent within the teachings of this disclosure. Runway Incursion Barrier System 25 will include physical barrier, post or bollard 200 and include potential Federal Aviation Administration (FAA) regulation 500 changes or other organization to allow these innovative systems in the industry. The physical barrier 200 will be designed as soft or flexible 300 and hardened or security 400. Interface Vector Imaging 50 will include an interface 600 and display 900. The interface 600 will be designed to streamline RIBS, IVI, and other aviation systems 700 with pilot and/or Air Traffic Control (ATC) 800 interaction.

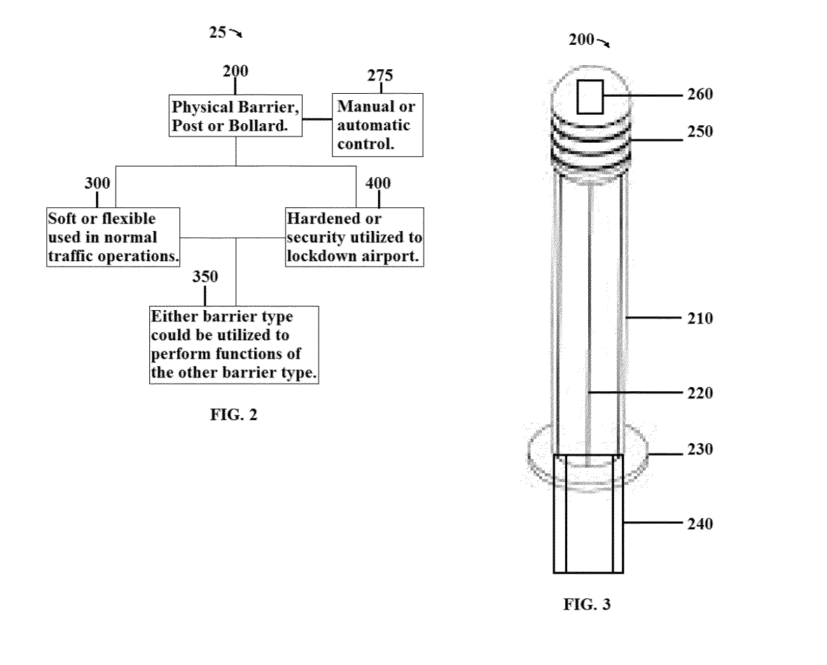

FIG. 2 is a block diagram of a Runway Incursion Barrier System 25 in accord with one possible embodiment of the present invention. Runway Incursion Barrier System 25 may comprise a physical barrier, post or bollard 200, manual or automatic control 275, soft or flexible type barrier used in normal traffic operations 300, hardened or security type barrier utilized to lockdown an airport 400, and either barrier type could be utilized to perform functions of the other barrier type 350.

The manual or automatic control 275 may include a mechanical switch for the purpose of normal control or emergency scenario.

A physical barrier 200 could comprise any conceivable shape, provided it comprises a physical portion. In a preferred embodiment, soft or flexible 300 and hardened or security 400 physical barriers may comprise metal, composite structure, or the like utilized in the transportation industry but could conceivably be made with any material suitable for traffic or security.

Power going to Runway Incursion Barrier System 25 could include any common form of power utilized in the transportation industry such as electric, hydraulic, combination of multiple forms or alternative forms such as solar.

FIG. 3 shows a perspective view of a physical barrier 200 with a housing area underground in accord with one possible embodiment of the present invention. The surface structure 210 will be constructed with the intention for ease of maintenance but with limited damage to aircraft and/or other vehicles and core structure 220 will be constructed depending on the individual airport requirements with traffic or safety needs. A base structure 230 will be flush to traffic way within traffic acceptable limitations to allow aircraft and/or vehicles to safely pass through with housing area underground 240. Markings 250 will consist of traditional airport markings or apparatus added to increase visual by pilots and lights 260 with an increased strength/dim function which would be utilized to increase/decrease visuals in night or weather requirements or conserve energy when not needed. Each physical barrier 200 will move in a manner to positively control ground movement by extending as a physical sign or move into the housing area underground 240 to allow aircraft and/or vehicles to pass.

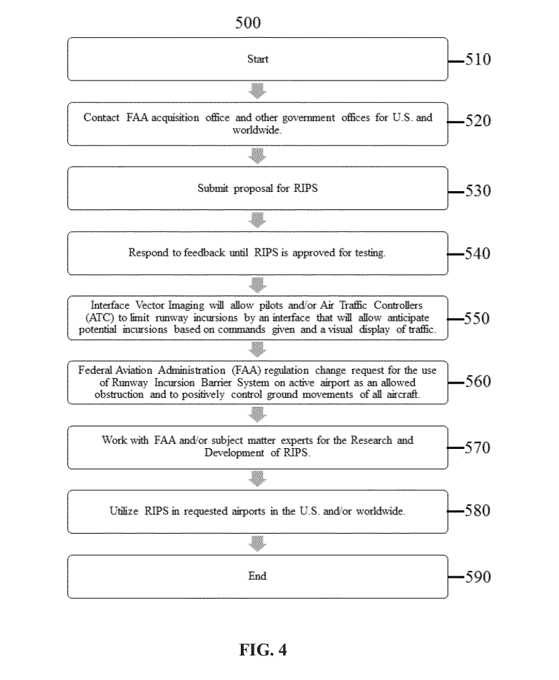

FIG. 4 is a flowchart of the life cycle for a Runway Incursion Prevention System 500 in accord with one possible embodiment of the present invention. First, begin the flowchart of the life cycle for a Runway Incursion Prevention System 500 with start 510. Next, contact with FAA acquisition office and other government offices for U.S. and worldwide 520, submit proposal for RIPS 530, and respond to feedback until RIPS is approved for testing 540. After that, Interface Vector Imaging will allow pilots and/or Air Traffic Controllers (ATC) to limit runway incursions by an interface that will anticipate potential incursions based on commands given and visual display of traffic 550. Meanwhile, Federal Aviation Administration (FAA) regulation change request for the use of Runway Incursion Barrier System on active airport as an allowed obstruction and to positively control ground movement of all vehicles or personnel 560. Then, work with FAA and/or subject matter experts for the Research and Development of RIPS 570. Furthermore, utilize RIPS in requested airports in the U.S. and/or worldwide 580. Finally, the Runway Incursion Prevention System life cycle 500 with end 590.

FIG. 5 is a perspective view of an Interface Vector Imaging 50 with interface 600 and display 900 in accord with one possible embodiment of the present invention. Interface Vector Imaging with interface and display screen 600 is an example from one of the worst accidents in U.S. history at Blue Grass Airport in Lexington, Ky. This descriptive layout shows how a map can be imported to the interface and utilizing disclosed features to prevent runway incursions. The taxiway to runway hold lines 610 and 620 which are potential locations for physical barriers but barriers could also be positioned and monitored at runway hold lines 630 to prevent errors in take-offs or landing operations. Monitored aircraft 630 should take-off from runway and direction 640 but does not. The monitored aircraft 630 takes-off in the wrong direction and runway shown in the examples 642, 644 and crash point 646. This was due to multiple errors and this system could have clearly prevented this type of runway incursion with error notifications. Aircraft take-off and landing direction 650 and 655 will also monitor this critical phase of operations. A point from the airport terminal/primary facility 660 is not an aircraft roadway but will display operations from the moment aircraft enter and leave the gate area. A possible air traffic control tower is shown from direction 670 but placement of any airport object will be based from imported maps at each given location. This is the result of each airport layout and overall design changing from one to another. The apron area 680 will show movement to and from gates. In addition, 690 aircraft barrier shows an area where aircraft are not allowed. Finally, runway incursions could become much more dangerous with two aircraft potentially crashing with the Tennerife accident in Mar. 27, 1977 as an example from the worst disaster in history. This system is designed to monitor airport operations and aims to prevent most or all of the estimated 75-85% of runway incursions by the FAA that can be prevented.

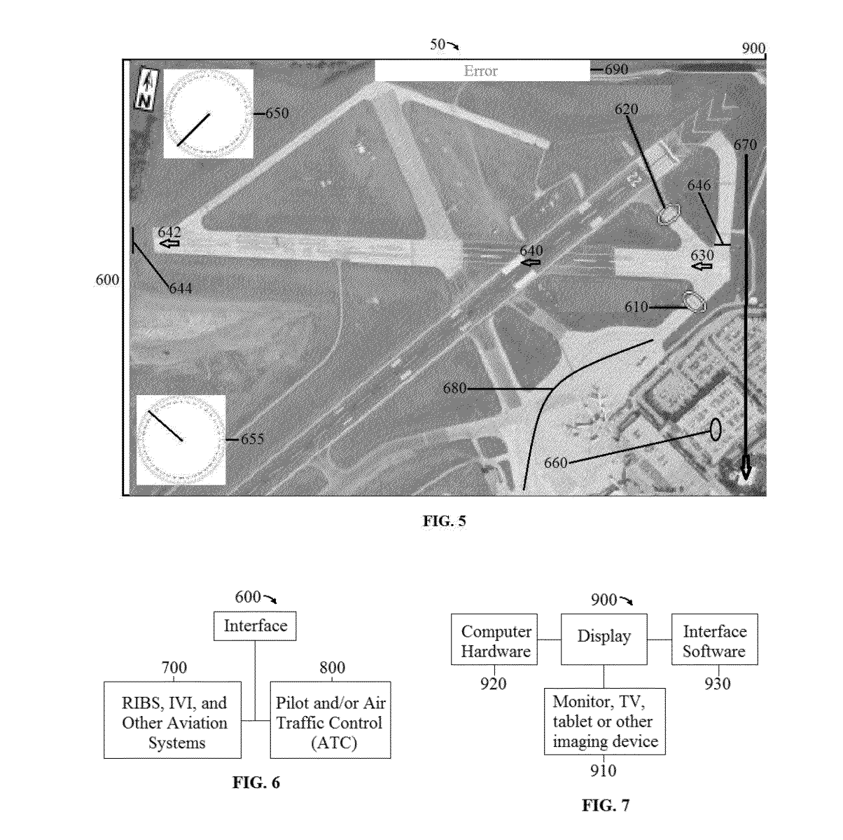

FIG. 6 is a block diagram of an interface 600 in accord with one possible embodiment of the present invention. Interface 600 may comprise communication between RIBS, IVI, and other aviation systems 700 and Pilot and/or Air Traffic Control (ATC) 800. RIBS, IVI, and other aviation systems 700 show how multiple systems can function through the interface to populate information such as surface detection from another system or operate RIBS through the interface. Pilot and/or Air Traffic Control (ATC) 800 displays how this system will mostly differ from other systems and which is interaction from the human element with error warnings.

FIG. 7 is a block diagram of a display 900 in accord with one possible embodiment of the present invention. Display 900 may comprise a monitor, TV, tablet or other imaging device 910, computer hardware 920 and interface software 930. Computer hardware 920 will be the standard base elements of a computer such as: hard drive, graphics card, memory to operate the display elements of the interface. Interface software 930 may or may not be utilized depending on customer request which will be an operating system or if interface 600 will be a stand-alone system.

In summary, the present invention provides various embodiments of a runway incursion prevention system shown in FIG. 1 to FIG. 7 with invention system 100 as discussed herein. The structure or organization of the Runway Incursion Barrier System 25 are discussed in FIG. 2. A modified configuration from the embodiment of a physical barrier 200 shown in FIG. 3. The flowchart of the life cycle for a Runway Incursion Prevention System 500 in accord with one possible embodiment of the present invention is shown in FIG. 4. A perspective view of an Interface Vector Imaging 50 with interface 600 and display 900 in accord with one possible embodiment of the present invention is shown in FIG. 5. The structure or organization of the interface 600 are discussed in FIG. 6 and the structure or organization of the display 900 is shown in FIG. 7.

The foregoing description of the preferred embodiments of the invention has been presented for purposes of illustration and description only. It is not intended to be exhaustive nor to limit the invention to the precise form disclosed; and obviously many modifications and variations are possible in light of the above teaching. Such modifications and variations that may be apparent to a person skilled in the art are intended to be included within the scope of this invention as defined by the accompanying claims.

1. A runway incursion prevention system for use to prevent runway incursions, the system comprising:
at least one of runway incursion barrier system utilizing physical barriers as a visual deterrent to control traffic; and an interface vector imaging by predicting runway incursions with human interaction.

2. The system of claim 1, wherein a runway incursion barrier system comprising:
at least one of physical barriers often referred to as a bollard are utilized to control ground movement; and physical barriers designed to traffic requirements; and
at least one of switch for manual and automatic control.

3. The system of claim 2, wherein physical barriers control ground movement by the presence of a physical obstruction as a sign that will notify clearance of traffic in hold line areas or other desired traffic areas of control.

4. The system of claim 2, wherein physical barriers are designed to airport requirements by at least one of soft physical barriers which are primarily utilized to operate normal traffic with minimal risk to aircraft and hardened physical barriers which are primarily utilized to lock down an area.

5. The system of claim 2, wherein said switch is at least one of a mechanical switch, light based switch, digital switch, sensor, automated system, and operation through an interface.

6. The system of claim 1, wherein an interface vector imaging comprising:
program or referred to herein as an interface and
display system, may comprise:
monitor, TV, tablet or other form of output device with a processor or general computer hardware utilized to run interface; and
at least one of sensor and surface detection system.

7. The system of claim 6, wherein an interface will predict the occurrence of runway incursions utilizing an automated analysis of common errors with human actions through clearance vectors or as traffic is directed to a desired point.

8. The system of claim 6, wherein an interface will enable a user to communicate with allowed aviation systems.

9. The system of claim 6, wherein an interface will enable a user to visually communicate clearance with at least one of pilot, Air Traffic Control (ATC) and other airport operations personnel.

10. The system of claim 6, wherein an interface is utilized to provide an image or display of an airport map, communicated data from other aviation systems, and human interaction through direction of traffic commands to visually monitor operations.

11. A runway incursion prevention method for use to prevent runway incursions, the method comprising:
at least one of runway incursion barrier method utilizing physical barriers as a visual deterrent to control traffic; and an interface vector imaging by predicting runway incursions with human interaction.

12. The method of claim 11, wherein a runway incursion barrier method comprising:
at least one of physical barriers often referred to as a bollard are utilized to control ground movement; and physical barriers designed to traffic requirements; and
at least one of switch for manual and automatic control.

13. The method of claim 12, wherein physical barriers control ground movement by the presence of a physical obstruction as a sign that will notify clearance of traffic in hold line areas or other desired traffic areas of control.

14. The method of claim 12, wherein physical barriers are designed to airport requirements by at least one of soft physical barriers which are primarily utilized to operate normal traffic with minimal risk to aircraft and hardened physical barriers which are primarily utilized to lock down an area.

15. The method of claim 12, wherein said switch is at least one of a mechanical switch, light based switch, digital switch, sensor, and type of automated method or operation through a type of interface.

16. The method of claim 1, wherein an interface vector imaging comprising:
program or referred to herein as an interface and
display method, may comprise:
monitor, TV, tablet or other form of output device with a processor or general computer hardware utilized to run interface, and at least one of sensor or surface detection method.

17. The method of claim 16, wherein an interface will predict the occurrence of runway incursions utilizing an automated analysis of common errors with human actions through clearance vectors or as traffic is directed to a desired point.

18. The method of claim 16, wherein an interface will enable a user to communicate with allowed aviation systems.

19. The method of claim 16, wherein an interface will enable a user to visually communicate clearance with at least one of pilot and Air Traffic Control (ATC) or other airport operations personnel.

20. The method of claim 16, wherein an interface is utilized to provide an image or display of an airport map, communicated data from other aviation systems, and human interaction through direction of traffic commands to visually monitor operations.
